(19) United States
(12) Patent Application Publication
(10) Pub. No.: US 2015/0105254 A1
(43) Pub. Date: Apr. 16, 2015

(54) AQUEOUS HERBICIDAL CONCENTRATES

(71) Applicant: DOW AGROSCIENCES LLC, Indianapolis, IN (US)

(72) Inventor: Mei Li, Westfield, IN (US)

(73) Assignee: DOW AGROSCIENCES LLC, Indianapolis, IN (US)

(21) Appl. No.: 14/511,288

(22) Filed: Oct. 10, 2014

Related U.S. Application Data
(60) Provisional application No. 61/889,808, filed on Oct. 11, 2013.

(51) Int. Cl. A01N 43/40; A01N 37/38

(52) U.S. Cl. CPC A01N 43/40; A01N 37/38
USPC 504/105; 504/130

(57) ABSTRACT

Aqueous based pesticide compositions having a high concentration of a water-soluble salt of a herbicide and a water-insoluble pesticide are provided herein. These compositions are, among other things, transparent, homogeneous, stable upon storage in various thermal environments, and upon dilution in water form a stable emulsion.

### I. CROSS REFERENCE TO RELATED APPLICATIONS

This application claims the benefit of U.S. Provisional Patent Application Ser. No. 61/889,808 filed Oct. 11, 2013.

### II. BACKGROUND

High-strength, e.g., high concentration or high-load, formulations are desirable for a variety of economic and environmental reasons, including the reduction of shipping and handling costs. Liquid pre-mix concentrates containing two or more active ingredients are useful in a wide variety of agricultural applications. For example, two or more pesticidal active ingredients may be combined in order to control a wider spectrum of pests, or to utilize multiple modes of action, compared to the individual active ingredients alone.

Normally, water insoluble pesticide active ingredients are formulated in water with water soluble pesticides as aqueous suspension concentrates (SC) or by dissolving the water insoluble pesticide in an organic solvent and forming an oil-in-water emulsion (EW). The preparation of these liquid, pre-mix concentrates can be challenging owing to chemical and/or physical instability. Examples of physical instability with these compositions include, for example, phase separation, crystallization, settling, sedimentation, gelling, and agglomeration.

Water soluble salts of pesticides, e.g., glyphosate salts, when dissolved in water form high ionic strength solutions that when combined with organic solutions containing oil-soluble pesticides normally form oil-in-water emulsions. These pre-mix, concentrate compositions, however, can be difficult to stabilize due to the high ionic strength of the aqueous phase and require the proper choice of surfactants and/or additional inert ingredients. Previous efforts to combine oil soluble herbicides with aqueous solutions containing salts of glyphosate in a liquid concentrate formulation have been disclosed, for example, in U.S. Pat. No. 6,713,433 B2, U.S. Pat. No. 6,689,719 and U.S. Pat. No. 6,369,001.

Previous efforts to prepare stable, homogeneous, herbicidal compositions containing water soluble salts of carboxylic acid herbicides and water insoluble herbicides were severely limited in the choice, physical properties and/or loading of the water insoluble herbicide.

### III. SUMMARY

Provided herein are stable aqueous herbicidal compositions comprising:
a) a water soluble salt of a synthetic auxin herbicide comprising, with respect to the total composition, from about 100 grams acid equivalent per liter (g ae/L) to about 625 g ae/L;
b) a second herbicide comprising, with respect to the total composition, from about 0.1 g ae/L to about 400 g ae/L of a water insoluble herbicide;
c) from about 0 g/L to about 150 g/L, with respect to the total composition, of at least one of an ionic and/or a non-ionic surfactant;
d) from about 0 g/L to about 500 g/L, with respect to the total composition, of a water immiscible organic solvent; and
e) from about 200 g/L to about 800 g/L, with respect to the total composition, of water;
   wherein the composition forms a stable, transparent, and homogenous herbicidal composition.

Also provided herein is a method of controlling undesirable vegetation comprising contacting the vegetation or an area adjacent thereto to prevent the emergence of growth of vegetation a herbicidally effective amount of a herbicidal composition comprising:
a) a water soluble salt of a synthetic auxin herbicide comprising, with respect to the total composition, from about 100 g ae/L to about 625 g ae/L;
b) a second herbicide comprising, with respect to the total composition, from about 0.1 g ae/L to about 400 g ae/L of a water insoluble herbicide;
c) from about 0 g/L to about 150 g/L, with respect to the total composition, of at least one of an ionic and/or a non-ionic surfactant;
d) from about 0 g/L to about 500 g/L, with respect to the total composition, of a water immiscible organic solvent; and
e) from about 200 g/L to about 800 g/L, with respect to the total composition, of water;
   wherein the composition forms a stable, transparent, and homogenous herbicidal composition.

### IV. DETAILED DESCRIPTION

The inventors herein have surprisingly found that combining an aqueous concentrate of a water soluble salt of a synthetic auxin herbicide such as, for example, 2,4-D with a water insoluble second herbicide, optionally dissolved in a organic solvent, provides a stable, transparent, and homogenous herbicidal composition that exhibits good storage stability even in the absence of any surfactants and readily forms a stable emulsion upon dilution into a spray solution of water.

Provided herein are stable aqueous herbicidal compositions comprising:
a) a water soluble salt of a synthetic auxin herbicide comprising, with respect to the total composition, from about 100 grams acid equivalent per liter (g ae/L) to about 625 g ae/L;
b) a second herbicide comprising, with respect to the total composition, from about 0.1 g ae/L to about 400 g ae/L of a water insoluble herbicide;
c) from about 0 g/L to about 150 g/L, with respect to the total composition, of at least one of an ionic and a non-ionic surfactant;
d) from about 0 g/L to about 500 g/L, with respect to the total composition, of a water immiscible organic solvent; and
e) from about 200 g/L to about 800 g/L, with respect to the total composition, of water;
   wherein the composition forms a stable, transparent, and homogenous herbicidal composition. These compositions also show no visible phase separation after storage at 54° C. for 2 weeks and/or no crystal formation after −10/40° C. freeze/thaw cycling conditions every 24 hours for 2 weeks.

In certain embodiments, the described compositions optionally include additional active ingredients and/or inert formulation ingredients.

In certain embodiments, the described compositions include a second herbicide that is a liquid or solid at ambient temperature.

In certain embodiments, the described compositions that include a liquid second herbicide do not include an organic solvent.

In certain embodiments, the described aqueous herbicide compositions form stable emulsions upon dilution into a spray solution containing water.

Also provided herein are methods of controlling undesirable vegetation comprising contacting the vegetation or an area adjacent thereto to prevent the emergence of growth of vegetation a herbicidally effective amount of a herbicidal composition comprising:
a) a water soluble salt of a synthetic auxin herbicide comprising, with respect to the total composition, from about 100 g ae/L to about 625 g ae/L;
b) a second herbicide comprising, with respect to the total composition, from about 0.1 g ae/L to about 400 g ae/L of an aminopyralid ester, carfentrazone, clethodim, a clopyralid ester, cloransulam-methyl, cyhalofop-butyl, a dicamba ester, diclosulam, florasulam, flumioxazin, fluoroxypyr-meptyl, halauxifen-methyl, a haloxyfop ester, a haloxyfop-P ester, haloxyfop-P-methyl, isoxaben, MCPA-EHE, an MCPB ester, mesotrione, metosulam, oxyfluorfen, penoxsulam, a picloram ester, propanil, pyrosulfotole, pyroxsulam, quizalofop-P-ethyl, saflufenacil, sethoxydim, sulfentrazone, tefuryltrione, topramezone, a non-liquid triclopyr ester, a compound having the following Formula

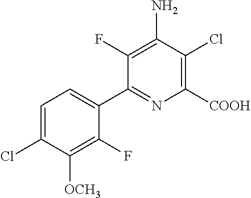 [SMILES: COc1c(Cl)ccc(-c2nc(C(=O)O)c(Cl)c(N)c2F)c1F]

or a C₁-C₁₂ alkyl or C₇-C₁₂ arylalkyl ester or salt thereof, or mixtures thereof;
c) from about 0 g/L to about 150 g/L, with respect to the total composition, of at least one of an ionic and/or a non-ionic surfactant;
d) from about 0 g/L to about 500 g/L, with respect to the total composition, of a water immiscible organic solvent; and
e) from about 200 g/L to about 800 g/L, with respect to the total composition, of water;
   wherein the composition forms a stable, transparent, and homogenous herbicidal composition.

A. Water Soluble Salts of Synthetic Auxin Herbicides

The term “water-soluble” in relation to a herbicide or a salt thereof as used herein means having solubility in deionized water at 20° C. sufficient to enable the water-soluble active ingredient to be dissolved completely in the aqueous phase of a composition at the desired concentration. In some embodiments, the water-soluble active ingredients useful in the compositions described herein have solubility in deionized water at 20° C. of not less than about 50 g/L or not less than about 200 g/L.

Synthetic auxin herbicides useful with the methods and compositions described herein include, for example, 2,4-D (2,4-dichlorophenoxyacetic acid), 2,4-DB (4-(2,4-dichlorophenoxy)butyric acid), aminocyclopyrachlor, aminopyralid, clopyralid, dicamba, MCPA, MCPB, picloram, triclopyr, or mixtures thereof.

The water-soluble salts of the synthetic auxin herbicides contained in the aqueous compositions described herein include, e.g., salts containing one or more cations selected from the class of organo ammonium cations, wherein the organo ammonium cations may have from 1 to about 12 carbon atoms. Exemplary organo ammonium cations include, for example, isopropyl ammonium, diglycol ammonium (2-(2-aminoethoxy)ethanol ammonium), dimethyl ammonium, diethyl ammonium, triethyl ammonium, monoethanol ammonium, dimethylethanol ammonium, diethanol ammonium, triethanol ammonium, triisopropanol ammonium, tetramethyl ammonium, tetraethylammonium, N,N,N-trimethylethanol ammonium (choline), and N,N-bis-(3-aminopropyl)methyl ammonium (BAPMA).

In some embodiments, the water-soluble salts of the synthetic auxin herbicides contained in the aqueous compositions described herein include, e.g., salts containing one or more cations selected from inorganic cations such as, for example, sodium and/or potassium. In certain embodiments, the water-soluble salt of the synthetic auxin herbicide is 2,4-D dimethyl ammonium or 2,4-D N,N,N-trimethylethanol ammonium (choline). In certain embodiments, the water-soluble salt of the synthetic auxin herbicide is a water soluble salt of aminopyralid, clopyralid, and/or dicamba. In certain embodiments, the water-soluble salt of the synthetic auxin herbicide is a water soluble salt of 2,4-D, MCPA, picloram, and/or triclopyr. In some embodiments the water-soluble salt of the synthetic auxin herbicide is dicamba dimethyl ammonium, dicamba diglycol ammonium, dicamba choline, dicamba N,N-bis-(3-aminopropyl)methyl ammonium (BAPMA), MCPA dimethyl ammonium, MCPA isopropyl ammonium, triclopyr triethyl ammonium, triclopyr dimethyl ammonium, and/or triclopyr choline.

In certain embodiments, the water soluble salt of the synthetic auxin herbicide comprises, with respect to the total composition, from about 100 grams acid equivalent per liter (g ae/L) to about 625 g ae/L, from about 100 to about 600 g ae/L, from about 100 to about 550 g ae/L, from about 200 to about 550 g ae/L, from about 200 to about 500 g ae/L, from about 200 to about 450 g ae/L, from about 200 to about 350 g ae/L, from about 200 to about 300 g ae/L, from about 200 to about 280 g ae/L or from about 200 to about 260 g ae/L. In certain embodiments, the water soluble salt of the synthetic auxin herbicide comprises, with respect to the total composition, from about 100 to about 450 g ae/L, from about 100 to about 400 g ae/L, from about 100 to about 350 g ae/L, from about 100 to about 300 g ae/L, from about 100 to about 250 g ae/L, from about 100 to about 200 g ae/L, or from about 100 to about 150 g ae/L. In certain embodiments, the water soluble salt of the synthetic auxin herbicide comprises, with respect to the total composition, from about 250 to about 550 g ae/L, from about 300 to about 550 g ae/L, from about 300 to about 525 g ae/L, from about 350 to about 525 g ae/L, from about 400 to about 525 g ae/L, from about 450 to about 525 g ae/L, from about 480 to about 510 g ae/L, from about 350 to about 500 g ae/L, from about 340 to about 450 g ae/L, from about 340 to about 400 g ae/L, from about 340 to about 380 g ae/L, from about 300 to about 400 g ae/L, from about 300 to about 380 g ae/L, from about 300 to about 360 g ae/L, from about 310 to about 350 g ae/L, or from about 320 to about 340 g ae/L.

The described aqueous compositions include at least one dissolved synthetic auxin herbicide salt, e.g., 2,4-D dimethyl ammonium or 2,4-D choline. The water-soluble synthetic auxin herbicide active ingredient of the compositions described herein, e.g., the herbicide 2,4-D dimethyl ammonium or 2,4-D choline, is present at a concentration in the composition as a whole sufficient, upon dilution of the composition in a suitable volume of water and applied by spraying to the target locus, to be herbicidally effective.

In some embodiments, the described compositions comprise from about 200 to about 625 g ae/L, from about 200 to about 575 g ae/L, from about 200 to about 525 g ae/L, from about 200 to about 475 g ae/L, from about 200 to about 425 g ae/L, from about 200 to about 375 g ae/L, from about 200 to about 350 g ae/L, from about 200 to about 300 g ae/L, from about 200 to about 280 g ae/L or from about 220 to about 260 g ae/L of 2,4-D dimethyl ammonium and/or 2,4-D choline.

In certain embodiments, the described compositions comprise from about 250 to about 625 g ae/L, from about 300 to about 625 g ae/L, from about 300 to about 575 g ae/L, from about 300 to about 525 g ae/L, from about 350 to about 525 g ae/L, from about 400 to about 525 g ae/L, from about 450 to about 525 g ae/L, from about 480 to about 510 g ae/L, from about 350 to about 625 g ae/L, from about 350 to about 575 g ae/L, from about 350 to about 525 g ae/L, from about 350 to about 475 g ae/L, from about 340 to about 450 g ae/L, from about 340 to about 400 g ae/L, from about 340 to about 380 g ae/L, from about 300 to about 400 g ae/L, from about 300 to about 380 g ae/L, from about 300 to about 360 g ae/L, from about 310 to about 350 g ae/L, or from about 320 to about 340 g ae/L of 2,4-D dimethyl ammonium and/or 2,4-D choline.

B. Second Herbicide

A second herbicide, meaning a herbicide active ingredient other than a water-soluble salt of a synthetic auxin herbicide and which may exist as a solid or a liquid at ambient temperature, may be included in the aqueous compositions described herein, optionally with the use of a water immiscible organic solvent. In certain embodiments the second herbicide is generally insoluble in water alone which refers to having solubility in deionized water at 20° C. of not greater than about 500 milligrams per liter (mg/L). In some embodiments the second herbicide has solubility in deionized water at 20° C. of not greater than about 100 mg/L. In some embodiments the second herbicide has solubility in deionized water at 20° C. of not greater than about 75 mg/L. In some embodiments the second herbicide has solubility in deionized water at 20° C. of not greater than about 50 mg/L. In some embodiments the second herbicide has solubility in deionized water at 20° C. of not greater than about 25 mg/L. In certain embodiments, the second herbicide is a solid having a melting point of not less than about 25° C. In certain embodiments, the second herbicide is a solid having a melting point of not less than about 50° C. In some embodiments, the second herbicide is a solid having a melting point of not less than about 100° C., and in other embodiments, the second herbicide is a solid having a melting point of not less than about 150° C.

The terms “liquid herbicide” or “liquid herbicide active ingredient,” as used herein, refers to those herbicides or herbicide active ingredients that exist as liquids at normal ambient temperatures of about 25° C., which, stated another way, means they have melting points of less than about 25° C. The terms “non-liquid fluoroxypyr ester” or “non-liquid triclopyr ester,” as used herein, refers to those esters of fluoroxypyr and triclopyr that exist as solids at normal ambient temperatures of about 25° C., which, stated another way, means they have melting points of not less than about 25° C. An example of a non-liquid fluoroxypyr ester is fluoroxypyr-meptyl. In some embodiments, the second herbicide is a liquid at ambient temperature. In some embodiments, the second herbicide is a liquid at ambient temperature and is present in the described compositions without the use of a water immiscible organic solvent.

Exemplary second herbicides for use with the methods and compositions described herein may be selected from, but are not limited to, esters of 4-CPA, 4-CPB, 4-CPP, 2,4-D, 3,4-DA, 2,4-DB, 3,4-DB, 2,4-DEB, 2,4-DEP, 3,4-DP, 2,4,5-T, 2,4,5-TB, and 2,3,6-TBA, allidochlor, acetochlor, acifluorfen, aclonifen, alachlor, alloxydim, alorac, ametridione, ametryn, amibuzin, amicarbazone, amidosulfuron, aminocyclopyrachlor esters, aminopyralid esters, amiprofos-methyl, amitrole, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofluor, benzoylprop, benzthiazuron, bicylopyrone, bifenox, bilanafos, bispyribac, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cafenstrole, cafenstrole, cambendichlor, carbasulam, carbasulam, carbetamide, carboxazole chlorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, clomeprop, cloprop, cloproxydim, clopyralid esters, cloransulam, CPMF, CPPC, credazine, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, di-allate, dicamba esters, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinitramine, dinofenate, dinoprop, dinosam, dinoseb, dinoterb, diphenamid, dipropetryn, diquat, disul, dithiopyr, diuron, DMPA, DNOC, EBEP, eglinazine, endothal, epronaz, epronaz, EPTC, erbon, esprocarb, ethalfluralin, ethametsulfuron, ethidimuron, ethiolate, ethofumesate, ethoxyfen, ethoxysulfuron, etinofen, etnipromid, etnipromid, etnipromid, etobenzanid, EXD, fenasulam, fenasulam, fenasulam, fenoprop, fenoxaprop, fenoxaprop-P, fenoxasulfone, fenteracol, fenthiaprop, fentrazamide, fenuron, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupoxam, flupropacil, flupropanate, flupyrsulfuron, fluridone, fluorochloridone, non-liquid fluoroxypyr esters, fluoroxypyr-meptyl, flurtamone, fluthiacet, fomesafen, fomesafen, foramsulfuron, fosamine, furyloxyfen, halauxfen, halauxfen-methyl, halosafen, halosafen, halosulfuron, haloxydine, haloxyfop, haloxyfop-P, hexazinone, imazamethabenz, imazamox, imazapic, imazapyr, imazaquin, imazethapyr, imazosulfuron, indanofan, indaziflam, iodobonil, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MCPA esters, MCPA-thioethyl, MCPA-EHE, MCPB esters, mecoprop, mecoprop-P, medinoterb, mefenacet, mefluidide, mesoprazine, mesosulfuron, mesotrione, metam, metamifop, metamifop, metamitron, metazachlor, metazosulfuron, metflurazon, methabenzthiazuron, methalpropalin, methazole, methiobencarb, methiozolin, methiuron, methiuron, methometon, methoprotryne, methyldymron, metobenzuron, metobromuron, metolachlor, S-metolachlor, metosulam, metoxuron, metribuzin, metsulfuron, molinate, monalide, monisouron, monolinuron, monuron, morfamquat, naproanilide, napropamide, naptalam, neburon, nicosulfuron, nipyraclofen, nitralin, nitrofen, nitrofluorfen, norflurazon, noruron, OCH, orbencarb, orthosulfamuron, oryzalin, oryzalin, oxadiargyl, oxadiazon, oxapyrazon, oxasulfuron, oxaziclomefone, oxyfluorfen, parafluoron, paraquat, pebulate, pelargonic acid, pendimethalin, penoxsulam, pentanochlor, pentoxazone, perfluidone, pethoxamid, phenisopham, phenmedipham, phenmedipham-ethyl, phenobenzuron, picloram esters, picolinafen, pinoxaden, piperophos, pretilachlor, primisulfuron, procyazine, prodiamine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyrosulfotole, pyroxasulfone, pyroxsulam, quinclorac, quinmerac, quinoclamine, quinonamid, quizalofop, quizalofop-P, rhodethanil, rimsulfuron, saflufenacil, sebuthylazine, secbumeton, sethoxydim, siduron, simazine, simeton, simetryn, sulcotrione, sulfallate, sulfentrazone, sulfometuron, sulfosulfuron, sulglycapin, swep, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, non-liquid triclopyr esters, thidiazimin, thidiazuron, thidiazuron, thiencarbazone-methyl, thifensulfuron, thiobencarb, tiocarbazil, tioclorim, topramezone, tralkoxydim, tri-allate, triasulfuron, triaziflam, tribenuron, tricamba, tridiphane, trietazine, trifloxysulfuron, trifluralin, triflusulfuron, trifop, trifopsime, trihydroxytriazine, trimeturon, tripropindan, tritac, tritosulfuron, vernolate, xylachlor and mixtures and derivatives thereof, and compounds of the following Formula

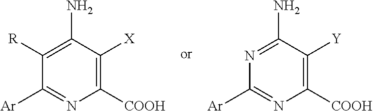

wherein
Ar represents a phenyl group substituted with one to four substituents independently selected from halogen, C₁-C₆ alkyl, C₁-C₆ alkoxy, C₂-C₄ alkoxyalkyl, C₂-C₆ alkylcarbonyl, C₁-C₆ alkylthio, C₁-C₆ haloalkyl, C₁-C₆ haloalkoxy, C₂-C₄ haloalkoxyalkyl, C₂-C₆ haloalkylcarbonyl, C₁-C₆ haloalkylthio, —OCH₂CH₂—, —OCH₂CH₂CH₂—, —OCH₂O— or —OCH₂CH₂O—;
R represents H or F;
X represents Cl or vinyl; and
Y represents Cl, vinyl or methoxy;
   and their salts and esters as disclosed, for example, in U.S. Pat. No. 7,314,849 B2, U.S. Pat. No. 7,300,907 B2, U.S. Pat. No. 7,786,044 B2 and U.S. Pat. No. 7,642,220 B2.

In some embodiments, the second herbicide is a 2,4-D ester, a 2,4-DB ester, amidosulfuron, an aminocyclopyrachlor ester, an aminopyralid ester, azimsulfuron, bensulfuron-methyl, benzofenap, bifenox, bromobutide, bromofenoxim, bromoxynil, carfentrazone, chlomethoxyfen, chlorbromuron, chlorimuron-ethyl, chlornitrofen, chlorotoluron, chlorsulfuron, chlorthal-dimethyl, clethodim, clodinafop, clomeprop, cloransulam-methyl, a clopyralid ester, cyclosulfamuron, cyhalofop, daimuron, desmedipham, a dicamba ester, dichlobenil, diclosulam, diflufenican, dimefuron, dinitramine, diuron, ethametsulfuron-methyl, ethoxysulfuron, fenoxaprop, fenoxaprop-P, flamprop, flazasulfuron, florasulam, fluazifop, fluazifop-P, flucetosulfuron, flumetsulam, flumiclorac-pentyl, flumioxazin, flupoxam, fluridone, a non-liquid fluoroxypyr ester, fluoroxypyr-meptyl, flurtamone, halauxifen-methyl, halosulfuron-methyl, haloxyfop, haloxyfop-P, imazamox, imazapic, imazaquin, imazosulfuron, iodosulfuron, ioxynil, ipfencarbazone, isoproturon, isoxaben, isoxapyrifop, lenacil, linuron, an MCPA ester, MCPA EHE, an MCPB ester, mefenacet, mesosulfuron, mesotrione, metamifop, metazosulfuron, methabenzthiazuron, metobenzuron, metosulam, metsulfuron, naproanilide, neburon, nicosulfuron, norflurazon, orthosulfamuron, oryzalin, oxadiazon, oxyfluorfen, penoxsulam, phenmedipham, a picloram ester, pinoxaden, primisulfuron-methyl, prodiamine, prometryn, propanil, propaquizafop, propazine, propyrisulfuron, propyzamide, pyrazolynate, pyrazosulfuron-ethyl, pyributicarb, pyriftalid, pyrimisulfan, pyrosulfotole, pyroxsulam, quinclorac, quizalofop, quizalofop-P, quizalofop-P-ethyl, rimsulfuron, saflufenacil, sethoxydim, siduron, simazine, sulfentrazone, tefuryltrione, terbuthylazine, terbutryn, thiazopyr, thifensulfuron-methyl, topramezone, tralkoxydim, tribenuron, a non-liquid triclopyr ester, trietazine, and mixtures and derivatives thereof.

In certain embodiments, the second herbicide for use in the described compositions is an aminopyralid ester, carfentrazone, clethodim, a clopyralid ester, cloransulam-methyl, cyhalofop-butyl, a dicamba ester, diclosulam, florasulam, flumioxazin, fluoroxypyr-meptyl, halauxifen-methyl, a haloxyfop ester, a haloxyfop-P ester, haloxyfop-P-methyl, isoxaben, MCPA-EHE, an MCPB ester, mesotrione, metosulam, oxyfluorfen, penoxsulam, a picloram ester, propanil, pyrosulfotole, pyroxsulam, quizalofop-P-ethyl, saflufenacil, sethoxydim, sulfentrazone, tefuryltrione, topramezone, a non-liquid triclopyr ester, and mixtures thereof.

In some embodiments the second herbicide for use in the described compositions includes compounds of the Formula

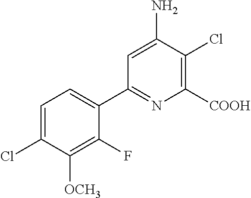 [SMILES: COc1c(Cl)ccc(-c2cc(N)c(Cl)c(C(=O)O)n2)c1F]

or a C₁-C₆ alkyl ester or salt thereof, e.g., the methyl ester, known as halauxifen-methyl or Arylex™ Active (trademark of Dow AgroSciences, LLC). In some embodiments, the second herbicide is a compound having the following Formula

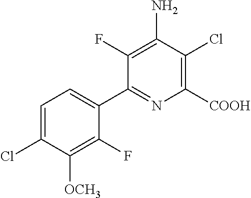 [SMILES: COc1c(Cl)ccc(-c2nc(C(=O)O)c(Cl)c(N)c2F)c1F]

or a C₁-C₁₂ alkyl or C₇-C₁₂ arylalkyl ester or salt thereof, e.g., the benzyl ester.

In certain embodiments, the second herbicide is fluoroxypyr-meptyl. In certain embodiments, the second herbicide is a combination of halauxifen-methyl and fluoroxypyr-meptyl. In certain embodiments, the second herbicide is isoxaben. In certain embodiments, the second herbicide is a combination of isoxaben and halauxifen-methyl.

In certain embodiments, the described compositions include a liquid herbicide active ingredient, which is not a liquid triclopyr ester or a liquid fluoroxypyr ester, as the second herbicide which may be used, optionally, with a water immiscible organic solvent. In certain embodiments, the described compositions include a liquid herbicide active ingredient as the second herbicide selected from a 2,4-D ester, a 2,4-DB ester, acetochlor, an aminocyclopyrachlor ester, an aminopyralid ester, butachlor, carfentazone-ethyl, a clopyralid ester, a dicamba ester, dimethenamid-P, a fluazifop-P ester, a haloxyfop-P ester, an MCPA ester, an MCPB ester, a mecoprop-P ester, metolachlor, S-metolachlor, a picloram ester, pretilachlor, and mixtures thereof.

In certain embodiments, the second herbicide is a liquid at ambient temperature and is selected from haloxyfop-methyl and/or haloxyfop-P-methyl. In certain embodiments, the second herbicide is a combination of halauxifen-methyl, and haloxyfop-methyl and/or haloxyfop-P-methyl.

In some embodiments, the second herbicide is present in the described compositions at from about 0.1 g ae/L to about 400 g ae/L, from about 0.1 g ae/L to about 300 g ae/L, from about 0.1 g ae/L to about 200 g ae/L, from about 0.1 g ae/L to about 150 g ae/L, from about 0.1 g ae/L to about 20 g ae/L, from about 0.1 g ae/L to about 15 g ae/L, from about 0.5 g ae/L to about 10 g ae/L, from about 1 g ae/L to about 10 g ae/L, from about 1 g ae/L to about 8 g ae/L, from about 1 g ae/L to about 7 g ae/L, from about 1 g ae/L to about 6 g ae/L, from about 1 g ae/L to about 5 g ae/L, from about 1 g ae/L to about 4 g ae/L, from about 1 g ae/L to about 3 g ae/L, from about 2 g ae/L to about 6 g ae/L, from about 3 g ae/L to about 6 g ae/L or from about 4 g ae/L to about 6 g ae/L. In some embodiments, the second herbicide is present in the described compositions at from about 10 g ae/L to about 400 g ae/L, from about 10 g ae/L to about 350 g ae/L, from about 10 g ae/L to about 300 g ae/L, from about 10 g ae/L to about 250 g ae/L, from about 10 g ae/L to about 200 g ae/L, from about 10 g ae/L to about 150 g ae/L, from about 10 g ae/L to about 130 g ae/L, from about 10 g ae/L to about 110 g ae/L, from about 10 g ae/L to about 100 g ae/L, from about 10 g ae/L to about 90 g ae/L, from about 10 g ae/L to about 80 g ae/L, from about 20 g ae/L to about 70 g ae/L, from about 20 g ae/L to about 60 g ae/L, from about 20 g ae/L to about 50 g ae/L or from about 30 g ae/L to about 40 g ae/L.

In some embodiments, the described compositions comprise from about 0.1 g ae/L to about 20 g ae/L, from about 0.1 g ae/L to about 15 g ae/L, from about 0.1 g ae/L to about 10 g ae/L, from about 0.5 g ae/L to about 10 g ae/L, from about 1 g ae/L to about 10 g ae/L, from about 1 g ae/L to about 8 g ae/L, from about 1 g ae/L to about 7 g ae/L, from about 1 g ae/L to about 5 g ae/L, from about 1 g ae/L to about 4 g ae/L, from about 1 g ae/L to about 3 g ae/L, from about 2 g ae/L to about 6 g ae/L, from about 3 g ae/L to about 6 g ae/L, or from about 4 g ae/L to about 6 g ae/L of halauxifen-methyl.

In some embodiments, the described compositions comprise from about 20 g ae/L to about 150 g ae/L, from about 40 g ae/L to about 150 g ae/L, from about 60 g ae/L to about 150 g ae/L, from about 80 g ae/L to about 150 g ae/L, from about 100 g ae/L to about 150 g ae/L, from about 125 g ae/L to about 150 g ae/L, from about 40 g ae/L to about 130 g ae/L, from about 50 g ae/L to about 120 g ae/L, from about 60 g ae/L to about 120 g ae/L, from about 70 g ae/L to about 120 g ae/L, from about 80 g ae/L to about 120 g ae/L, from about 10 g ae/L to about 120 g ae/L, from about 10 g ae/L to about 100 g ae/L, from about 10 g ae/L to about 90 g ae/L, from about 10 g ae/L to about 80 g ae/L, from about 10 g ae/L to about 70 g ae/L, from about 20 g ae/L to about 60 g ae/L, from about 20 g ae/L to about 50 g ae/L, from about 30 g ae/L to about 40 g ae/L, from about 30 g ae/L to about 90 g ae/L, from about 40 g ae/L to about 90 g ae/L, from about 50 g ae/L to about 90 g ae/L, from about 60 g ae/L to about 90 g ae/L, or from about 70 g ae/L to about 85 g ae/L of fluoroxypyr-meptyl.

In some embodiments, the described compositions comprise from about 20 g ae/L to about 400 g ae/L, from about 50 g ae/L to about 400 g ae/L, from about 75 g ae/L to about 400 g ae/L, from about 100 g ae/L to about 400 g ae/L, from about 150 g ae/L to about 400 g ae/L, from about 200 g ae/L to about 400 g ae/L, from about 250 g ae/L to about 400 g ae/L, from about 300 g ae/L to about 400 g ae/L, or from about 325 g ae/L to about 375 g ae/L of haloxyfop-methyl and/or haloxyfop-P-methyl.

In some embodiments the weight ratio, on an ae basis, of the water-soluble salt of the synthetic auxin herbicide to the one or more second herbicide in the described compositions may range from about 6250:1 to about 1:4, from about 5500:1 to about 1:4, from about 4000:1 to about 1:4, from about 2500:1 to about 1:4, from about 1500:1 to about 1:4, from about 500:1 to about 1:4, from about 400:1 to about 1:4, from about 300:1 to about 1:4, from about 200:1 to about 1:4, from about 150:1 to about 1:4, from about 125:1 to about 1:4, from about 100:1 to about 1:4, from about 75:1 to about 1:4, from about 50:1 to about 1:4, from about 25:1 to about 1:4, from about 15:1 to about 1:4, from about 10:1 to about 1:4, from about 8:1 to about 1:4, from about 7:1 to about 1:4, from about 6:1 to about 1:4, from about 5:1 to about 1:4, from about 4:1 to about 1:4, from about 3:1 to about 1:4, or from about 2:1 to about 1:4.

In some embodiments the weight ratio, on an ae basis, of a 2,4-D organo ammonium salt to halauxifen-methyl in the described compositions ranges from about 6250:1 to about 5:1, from about 4000:1 to about 5:1, from about 2500:1 to about 5:1, from about 1500:1 to about 5:1, from about 500:1 to about 5:1, from about 400:1 to about 5:1, from about 300:1 to about 5:1, from about 200:1 to about 5:1, from about 150:1 to about 5:1, from about 125:1 to about 5:1, from about 100:1 to about 5:1, from about 75:1 to about 5:1, from about 50:1 to about 5:1, from about 25:1 to about 5:1, or from about 15:1 to about 5:1.

In some embodiments the weight ratio, on an ae basis, of a 2,4-D organo ammonium salt to fluoroxypyr-meptyl in the described compositions may range from about 30:1 to about 2:3, from about 25:1 to about 2:3, from about 20:1 to about 2:3, from about 15:1 to about 2:3, from about 10:1 to about 2:3, from about 8:1 to about 2:3, from about 7:1 to about 2:3, from about 6:1 to about 2:3, from about 5:1 to about 2:3, from about 4:1 to about 2:3, from about 3:1 to about 2:3, or from about 2:1 to about 2:3.

In some embodiments the weight ratio, on an ae basis, of a 2,4-D organo ammonium salt to haloxyfop-methyl and/or haloxyfop-P-methyl in the described compositions may range from about 30:1 to about 1:4, from about 25:1 to about 1:4, from about 20:1 to about 1:4, from about 15:1 to about 1:4, from about 10:1 to about 1:4, from about 8:1 to about 1:4, from about 7:1 to about 1:4, from about 6:1 to about 1:4, from about 5:1 to about 1:4, from about 4:1 to about 1:4, from about 3:1 to about 1:4, or from about 2:1 to about 1:4.

Some second herbicide active ingredients described herein do not contain an acid-type functional group and, for these active ingredients, the terms “acid equivalent” and “acid equivalent basis” are not accurate to describe the amount of the second herbicide present. Generally, in such instances, the terms “active ingredient” or “active ingredient basis” can be used to describe the amount of the second herbicide active ingredient present. For example, grams active ingredient per liter (g ai/L) may be used in place of grams acid equivalent per liter (g ae/L), or grams active ingredient per kilogram (g ai/kg) may be used in place of grams acid equivalent per kilogram (g ae/kg) when the active ingredient does not have an acid equivalent.

C. Surfactants

In some embodiments, the compositions described herein may include one or more surfactants. In some embodiments, the compositions described herein may not include a surfactant. Surfactants useful with the methods and compositions described herein include ionic and/or nonionic surfactants such as, for example, phosphate ester surfactants, polymeric surfactants, or mixtures thereof. Examples of useful polymeric surfactants include AB or ABA block copolymers; block or graft acrylate or methacrylate copolymers; and alkyd polyethylene oxide resins. Useful polymeric surfactants include (1) AB block copolymers that contain EO and PO blocks such as ethylene oxide-propylene oxide (EO-PO) block copolymers and (2) ABA block copolymers having a hydrophilic portion of polyethylene oxide and a hydrophobic portion of poly(12-hydroxystearate). Examples of useful phosphate ester surfactants include acids or salts of mono and dialkyl phosphate esters; acids or salts of ethoxylated mono and dialkyl phosphate esters; acids or salts of mono and dialkyl phosphate esters of ethoxylated tristyrylphenol; acids or salts of mono and dialkyl phosphate esters of ethoxylated phenol and ethoxylated alkylphenols; and mixtures thereof.

In some embodiments the at least one ionic and/or nonionic surfactant is Atlox™ 4912 (Croda; Edison, N.J.), and/or Termul™ 2510 (Huntsman International LLC; The Woodlands, Tex.), and/or Atlox DP 13/6.

In some embodiments, the described compositions comprise, with respect to the total composition, from about 0 g/L to about 150 g/L, from about 0 g/L to about 125 g/L, from about 0 g/L to about 100 g/L, from about 0 g/L to about 75 g/L, from about 0 g/L to about 50 g/L, from about 0 g/L to about 40 g/L, from about 0 g/L to about 30 g/L, from about 0 g/L to about 20 g/L, from about 0 g/L to about 10 g/L, from about 0 g/L to about 5 g/L, or from about 0 g/L to about 3 g/L of one or more surfactants. In certain embodiments, the described compositions comprise from about 10 g/L to about 100 g/L, from about 10 g/L to about 90 g/L, from about 10 g/L to about 80 g/L, from about 10 g/L to about 70 g/L, from about 10 g/L to about 60 g/L, from about 10 g/L to about 50 g/L, from about 20 g/L to about 50 g/L, from about 20 g/L to about 40 g/L, or from about 20 g/L to about 30 g/L of one or more surfactants.

D. Water Immiscible Organic Solvent

A “water immiscible organic solvent” as defined herein means an organic solvent that when mixed with an equivalent volume of water forms two discrete liquid layers. In some embodiments, the described compositions include a water immiscible organic solvent. In some embodiments, the water immiscible organic solvent serves as a carrier for the second herbicide, which may be a solid or a liquid, and provides improved solubility of the second herbicide in the described aqueous herbicidal compositions and improved storage stability for such compositions.

Examples of water immiscible organic solvents that are especially useful with the methods and compositions described herein include those derived from or made from natural, non-petroleum sources such as, for example, plants and animals, and include, vegetable oils, seed oils, animal oils and the like. Such naturally derived oils, and organic solvents derived or made from them, generally have improved safety and environmental profiles when compared to petroleum derived solvents. Especially useful naturally derived, water immiscible, organic solvents include the fatty acid dialkylamides such as, e.g., N,N-dimethylcaprylamide (N,N-dimethyloctanamide), N,N-dimethylcapramide (N,N-dimethyldecanamide), and mixtures thereof, which are available commercially as Agnique® AMD 810 and Agnique® AMD 10, from BASF Corp. (Florham Park, N.J.), Genegen® 4166, Genegen® 4231 and Genegen® 4296, from Clariant (Charlotte, N.C.), Hallcomid M-8-10 and Hallcomid M-10, from Stepan (Northfield, Ill.), and Amid DM10 and DM810 from AkzoNobel (Chicago, Ill.). Additional examples of naturally derived organic solvents include the morpholine amides of caprylic/capric fatty acids (C₈/C₁₀) which are commercially available as JEFFSOL® AG-1730 Solvent from Huntsman International LLC (The Woodlands, Tex.).

In some embodiments, the described compositions include a water immiscible organic solvent selected from, but not limited to, one or more of petroleum fractions or hydrocarbons such as aromatic hydrocarbons, mixed naphthalene and alkyl naphthalene fractions, aromatic solvents, particularly alkyl substituted benzenes such as xylene or propylbenzene fractions, and the like; C₁-C₆ esters of fatty acids derived from vegetable, seed or animal oils such as, methyl caproate, methyl caprylate, methyl caprate, methyl laurate, methyl myristate, methyl palmitate, methyl stearate, methyl oleate, methyl linoleate, methyl linolenate, and the like; ketones such as isophorone and trimethylcyclohexanone (dihydroisophorone); acetate esters such as, methyl, ethyl, propyl, butyl, pentyl, hexyl, or heptyl acetate, and the like; and cyclic alkyl carbonates such as propylene carbonate and butylene carbonate, which are available as the JEFFSOL® alkylene carbonates from Huntsman (The Woodlands, Tex.), and dibutyl carbonate, also from Huntsman, and mixtures of any of the water immiscible organic solvents described herein.

In some embodiments, the water immiscible organic solvent may comprise, with respect to the total composition, from 0 to about 60 percent by weight.

In some embodiments, the compositions described herein comprise from about 0 g/L to about 500 g/L, from about 10 g/L to about 500 g/L, from about 10 g/L to about 450 g/L, from about 10 g/L to about 400 g/L, from about 10 g/L to about 350 g/L, from about 10 g/L to about 300 g/L, from about 10 g/L to about 250 g/L, from about 10 g/L to about 200 g/L, from about 10 g/L to about 150 g/L, from about 10 g/L to about 100 g/L, from about 10 g/L to about 80 g/L, from about 10 g/L to about 70 g/L, from about 20 g/L to about 70 g/L, from about 30 g/L to about 60 g/L, from about 30 g/L to about 50 g/L, or from about 35 g/L to about 45 g/L of a water immiscible organic solvent.

In some embodiments, the compositions described herein comprise from about 0 g/L to about 450 g/L, from about 0 g/L to about 400 g/L, from about 0 g/L to about 350 g/L, from about 0 g/L to about 300 g/L, from about 0 g/L to about 250 g/L, from about 0 g/L to about 200 g/L, from about 0 g/L to about 150 g/L, from about 0 g/L to about 100 g/L, from about 0 g/L to about 80 g/L, from about 0 g/L to about 70 g/L, from about 0 g/L to about 60 g/L, from about 0 g/L to about 50 g/L, from about 0 g/L to about 40 g/L, from about 0 g/L to about 40 g/L, from about 0 g/L to about 30 g/L, from about 0 g/L to about 20 g/L, or from about 0 g/L to about 10 g/L of a water immiscible organic solvent.

In some embodiments, the compositions described herein comprise from about 50 g/L to about 450 g/L, from about 75 g/L to about 400 g/L, from about 100 g/L to about 400 g/L, from about 125 g/L to about 375 g/L, from about 150 g/L to about 350 g/L, from about 170 g/L to about 330 g/L, from about 170 g/L to about 300 g/L, from about 170 g/L to about 275 g/L, from about 170 g/L to about 250 g/L, from about 170 g/L to about 230 g/L, from about 180 g/L to about 230 g/L, from about 190 g/L to about 230 g/L, from about 200 g/L to about 230 g/L, or from about 210 g/L to about 230 g/L of a water immiscible organic solvent.

E. Water

The compositions described herein comprise from about 200 g/L to about 800 g/L of water. The water serves as both an aqueous solvent and a carrier for the ingredients in the described compositions. In some embodiments, the compositions described herein comprise from about 200 g/L to about 700 g/L, from about 200 g/L to about 600 g/L, from about 200 g/L to about 500 g/L, from about 200 g/L to about 400 g/L, from about 250 g/L to about 400 g/L, from about 275 g/L to about 400 g/L, from about 300 g/L to about 400 g/L, from about 325 g/L to about 400 g/L, or from about 325 g/L to about 375 g/L of water.

F. Storage Stability

As used herein, “stable” compositions are compositions that are stable physically and/or chemically for defined periods of time to the environments in which they are produced, transported and/or stored. Aspects of stable compositions include, but are not limited to: physical stability at temperatures that range from about 0° C. to about 54° C., homogeneity, pourability, liquids that form little or no precipitated solids or exhibit little or no phase separation, compositions that readily dissolve or disperse when poured into a spray tank of water and retain their biological efficacy when applied, for example, by spray application to target pests. In some embodiments, the compositions form stable, homogeneous concentrates that do not exhibit phase separations under the storage conditions. In some embodiments, the described compositions exhibit very little change in viscosity under the storage conditions. In some embodiments, the described compositions exhibit very little chemical decomposition of the active ingredients under the storage conditions.

As used herein, the term “transparent, homogenous herbicidal composition” means compositions that pass light through with clarity. Stated another way, the transparent, homogeneous herbicidal compositions are visually clear to the naked eye.

In some embodiments, the described compositions are stable at temperatures of greater than or equal to about 25° C. for a period of at least 2, 4, 6 or 8 weeks. In some embodiments, the described compositions are stable at temperatures of greater than or equal to about 40° C. for a period of at least 4, 6 or 8 weeks. In some embodiments, the described compositions are stable at temperatures greater than or equal to about 54° C. for a period of at least about 2 weeks.

In some embodiments, the compositions do not exhibit or do not significantly exhibit separation or precipitation (or crystallization) of any of the components at low temperatures. In some embodiments, the described compositions remain as homogeneous concentrates for at least about 2 weeks at temperatures below about 20° C., below about 10° C., or equal to or less than about 5° C., or equal to or less than about 0° C., or equal to or less than about −5° C., or equal to or less than about −10° C. In certain embodiments, the compositions are stable at these temperatures for at least about 2, 4, 6, or 8 weeks.

In some embodiments, the compositions remain as homogeneous concentrates after subjecting them to freeze/thaw (F/T) conditions for at least about 2 weeks where the temperature is cycled from about −10° C. to about 40° C. every 24 hours.

G. Optional Ingredients

The compositions disclosed herein may optionally contain inert formulation ingredients such as, but not limited to, dispersants, surfactants and wetting agents. These optional inert ingredients may include surfactants conventionally used in the art of formulation that are described, inter alia, in “McCutcheon's Detergents and Emulsifiers Annual,” MC Publishing Corp., Ridgewood, N.J., 1998 and in the “Encyclopedia of Surfactants,” Vol. I-III, Chemical Publishing Co., New York, 1980-81. These surface-active agents can be anionic, cationic or nonionic in character and can be employed as emulsifying agents, wetting agents, suspending agents, or for other purposes.

In addition to the specific methods and compositions set forth above, the methods and compositions described herein also may include compositions containing one or more additional compatible ingredients. These additional ingredients may include, for example, one or more pesticides or other ingredients, which may be dissolved or dispersed in the composition and may be selected from acaricides, algicides, antifeedants, avicides, bactericides, bird repellents, chemosterilants, defoliants, desiccants, disinfectants, fungicides, herbicide safeners, herbicides, insect attractants, insecticides, insect repellents, mammal repellents, mating disrupters, molluscicides, nematicides, plant activators, plant growth regulators, rodenticides, semiochemicals, synergists, and virucides. Also, any other additional ingredients providing functional utility such as, for example, antifoam agents, antimicrobial agents, buffers, corrosion inhibitors, dispersing agents, dyes, fragrants, freezing point depressants, neutralizing agents, odorants, penetration aids, sequestering agents, spray drift control agents, spreading agents, stabilizers, sticking agents, viscosity-modifying additives, water soluble solvents and the like, may be included in these compositions.

When the described compositions are used in combination with the additional active ingredients such as, for example, herbicide active ingredients, the compositions described herein can be formulated with the other active ingredient or active ingredients as premix concentrates, tank-mixed in water with the other active ingredient or active ingredients for spray application or applied sequentially with the other active ingredient or active ingredients in separate spray applications.

H. Methods of Preparation and Use

In some embodiments, the compositions described herein are prepared by the steps of:

(1) preparing a solution of the one or more second herbicide in the organic solvent and, optionally, including a surfactant;

(2) adding the solution prepared in step (1) to a concentrated solution of a water-soluble salt of a synthetic auxin herbicide in water with good mixing to form a clear solution; and

(3) optionally, adding any additional compatible active or inert ingredients.

In some embodiments, the compositions described herein are prepared by the steps of:

(1) providing a second herbicide that is a liquid and, optionally, mixing it with the organic solvent and, optionally, including a surfactant;

(2) adding the composition prepared in step (1) to a concentrated solution of a water-soluble salt of a synthetic auxin herbicide in water with good mixing to form a clear solution; and

(3) optionally, adding any additional compatible active or inert ingredients.

Exemplary water compatible ingredients that may be added to the described compositions include, but are not limited to, water soluble or water insoluble dispersing surfactants, water insoluble active ingredients and optionally, other inert ingredients such as pH buffers, wetting agents, antifreeze agents, antifoam agents, biocides, etc.

The aqueous herbicidal compositions described herein may optionally be diluted in an aqueous spray mixture for agricultural application such as for weed control in crop fields or in turf. Such compositions are typically diluted with an inert carrier, such as water, before application. The diluted compositions, which are usually applied, for example, to weeds, the locus of weeds or the locus of where weeds may eventually emerge, in some embodiments contain about 0.0001 to about 5 weight percent of the active ingredient or from 0.001 to about 0.1 weight percent of the active ingredient. The present compositions can be applied, for example, to weeds or their locus by the use of conventional ground or aerial sprayers, by addition to irrigation water and by other conventional means known to those skilled in the art.

The compositions and methods described herein may be used in controlling undesirable vegetation in crops possessing single, multiple or stacked genomic traits conferring tolerance to one or more herbicide chemistries and/or inhibitors with single or multiple modes of action.

### I. EXAMPLES

The following Examples are presented to illustrate various aspects of the compositions described herein and should not be construed as limitations to the claims.

### Example 1

### 2,4-D choline Salt Aqueous Concentrate

A 2,4-D choline salt aqueous concentrate solution was prepared by reacting 2,4-D acid technical with an equimolar amount of choline hydroxide in water at ambient temperature. Additional water was then added, if needed, to reach a target 2,4-D acid equivalent (ae) concentration of 45.7 wt %.

### Example 2

### 2,4-D dimethylammnoium (2,4-D DMA) Salt Aqueous Concentrate

A 2,4-D DMA salt aqueous concentrate solution was prepared by reacting 2,4-D acid technical with an equimolar amount of dimethylamine (40 wt %) aqueous solution in water at ambient temperature. Additional water was then added, if needed, to reach a target 2,4-D acid equivalent (ae) concentration of 55.3 wt %.

### Examples 3 to 6

### Herbicidal Aqueous Compositions of 2,4-D DMA and a Liquid Second Herbicide, haloxyfop-P-methyl ester

Examples 3 to 6 were prepared by adding haloxyfop-P-methyl ester, optionally dissolved in Genagen 4166, to a 2,4-D DMA aqueous concentrate to provide the compositions described in Table 1 below. Transparent and homogenous aqueous compositions were formed by mixing the samples by hand shaking. No crystal formation/growth or phase separation was observed with any of the samples after: (1) 2 weeks of storage at freeze-thaw (F/T) conditions (−10° C./40° C. cycle every 24 hours), and (2) 2 weeks of storage at 0° C. The melting point of each sample was less than −15° C. according to differential scanning calorimetry (DSC) measurement. Diluting a 1% sample of each sample in tap water resulted in an opaque, oil-in-water emulsion.

TABLE 1
Concentrate Compositions Containing 2,4-D DMA and Haloxyfop-P-methyl¹

| | 2,4-D DMA | Haloxyfop- | Genagen | 2,4-D | Haloxyfop- |
|---|---|---|---|---|---|
| Sample | Concentrate² | P-methyl | 4166 | Content in | P-methyl |
| ID | (wt, g) | (wt, g) | (wt, g) | ae (wt %) | (wt %) |
| Example 3 | 20.0 | 0.5 | 0 | 54.0% | 2.4% |
| Example 4 | 19.0 | 1.0 | 0 | 52.5% | 5.0% |
| Example 5 | 14.0 | 5.0 | 6.0 | 31.0% | 20.0% |
| Example 6 | 10.0 | 10.0 | 10.0 | 18.4% | 33.3% |

¹The four concentrate compositions were stable after storage for an extended period of time at room temperature.
²The sample prepared in Example 2 was used as the 2,4-DMA concentrate for preparing the samples described in Examples 3 to 6.

### Example 7

### Halauxifen-methyl Concentrate in Genagen 4166 Solvent

A halauxifen-methyl concentrate solution in Genagen 4166 solvent was prepared by dissolving halauxifen-methyl (10.42 active ingredient (ai) wt %) in Genagen 4166 solvent (89.58 wt %) with mixing until a clear solution was obtained at ambient temperature.

### Example 8

### Herbicidal Aqueous Composition of 2,4-D DMA and halauxifen-methyl

The halauxifen-methyl concentrate solution (Example 7, 4.5 g), Dowanol DPM (5.75 g), Atlox 4912 (0.25 g), and Atlox DP 13/6 (2.0 g) were mixed together to provide a homogeneous organic phase, to which the 2,4-D DMA aqueous concentrate (Example 2, 78.0 g) and additional water (9.5 g) were added. Upon mild hand mixing, a transparent and homogenous, aqueous solution was formed that remained as a transparent and homogenous solution without any crystal formation/growth or phase separation after: (1) 2 weeks of storage at freeze-thaw (F/T) conditions (−10° C./40° C. cycle every 24 hours), and (2) 2 weeks of storage at 0° C. The melting point of the sample was less than −10° C. according to differential scanning calorimetry (DSC) measurement. The active ingredients, halauxifen-methyl and 2,4-D, in the composition were found to be chemically stable, according to the FAO (Food and Agriculture Organization of the United Nations) guidelines on active ingredient retention, after 2 weeks of storage at 54° C.

### Example 9

### Herbicidal Aqueous Composition of 2,4-D choline and halauxifen-methyl

The halauxifen-methyl concentrate solution (Example 7, 4.5 g), Atlox 4912 (0.25 g), and Atlox DP 13/6 (2.0 g) were mixed well together to provide a homogeneous organic phase, to which the 2,4-D choline aqueous concentrate (Example 1, 87.5 g) and additional water (5.75 g) was added. Upon mild hand mixing, a transparent and homogenous, aqueous solution was formed that remained as a transparent and homogenous solution without any crystal formation/growth or phase separation after: (1) 2 weeks of storage at freeze-thaw (F/T) conditions (−10° C./40° C. cycle every 24 hours), and (2) 2 weeks of storage at 0° C. The melting point of the sample was less than −10° C. according to differential scanning calorimetry (DSC) measurement. The active ingredients, halauxifen-methyl and 2,4-D, in the composition were found to be chemically stable, according to the FAO guidelines on active ingredient retention, after 2 weeks of storage at 54° C. Diluting a 1% sample of this solution in 342 ppm hardness water resulted in the formation of a transparent solution to the naked eye.

### Example 10

### Halauxifen-methyl and fluoroxypyr-MHE Concentrate in Genagen 4166 Solvent

An halauxifen-methyl/fluoroxypyr-meptyl concentrate solution in Genagen 4166 solvent was prepared by dissolving halauxifen-methyl (2.25 active ingredient (ai) wt %) and fluoroxypyr-meptyl (48.36 ai wt %) in Genagen 4166 solvent (49.39 wt %) with mixing until a clear solution was obtained at ambient temperature.

### Example 11

### Herbicidal Aqueous Composition of 2,4-D choline, halauxifen-methyl and fluoroxypyr-meptyl

The halauxifen-methyl/fluoroxypyr-meptyl concentrate solution (Example 10, 13.33 g), additional Genagen 4166 solvent (12.42 g), Atlox 4912 (0.25 g), and Atlox DP 13/6 (2.0 g) were mixed together to provide a homogeneous organic phase, to which the 2,4-D choline aqueous concentrate (Example 1, 72.0 g) was added. Upon mild hand mixing, a transparent and homogenous, aqueous solution was formed with a pH of 7.05 that remained as a transparent and homogenous solution without any crystal formation/growth or phase separation after: (1) 2 weeks of storage at freeze-thaw (F/T) conditions (−10° C./40° C. cycle every 24 hours), and (2) 2 weeks of storage at 54° C. The active ingredients in the composition were found to be chemically stable as evidenced by >95% retention of the halauxifen-methyl, fluoroxypyr-meptyl and 2,4-D after 2 weeks of storage at 54° C. The melting point of the sample was less than −20° C. according to differential scanning calorimetry (DSC) measurement. Diluting a 1% sample of this solution in 342 ppm hardness water resulted in the formation of an opaque, oil-in-water emulsion.

### Example 12

### Herbicidal Aqueous Composition of 2,4-D choline, halauxifen-methyl and fluoroxypyr-meptyl

The halauxifen-methyl/fluoroxypyr-meptyl concentrate solution (Example 10, 13.33 g) and additional Genagen 4166 solvent (14.67 g) were mixed well together to provide a homogeneous organic phase, to which the 2,4-D choline aqueous concentrate (Example 1, 72.0 g) was added. Upon mild hand mixing, a transparent and homogenous aqueous solution was formed with a pH of 7.3 that remained as a transparent and homogenous solution without any crystal formation/growth or phase separation after: (1) 2 weeks storage at freeze-thaw (F/T) conditions (−10° C./40° C. cycle every 24 hours), and (2) storage at 54° C. for 2 weeks. Diluting a 5% sample of this solution in 342 ppm hardness water resulted in the formation of an opaque, oil-in-water emulsion. The droplet size of the emulsion was analyzed using a Mastersizer 2000 (Malvern Instruments, UK) and found to be 3.0 microns (D₅₀). The emulsion was free of cream or oil formation after 24 hours at ambient temperature.

### Example 13

### Herbicidal Aqueous Composition of 2,4-D DMA, halauxifen-methyl and fluoroxypyr-meptyl

The halauxifen-methyl/fluoroxypyr-meptyl concentrate solution (Example 10, 17.5 g), Dowanol DPM (4.25 g), Atlox 4912 (0.25 g), and Atlox DP 13/6 (2.0 g) were mixed well together to provide a homogeneous organic phase, to which the 2,4-D DMA aqueous concentrate (Example 2, 76.0 g) was added. Upon mild hand mixing, a transparent and homogenous aqueous solution was formed that remained as a transparent and homogenous solution without any crystal formation/growth or phase separation after: (1) 2 weeks of storage at freeze-thaw (F/T) conditions (−10° C./40° C. cycle every 24 hours), and (2) 2 weeks of storage at 54° C. The melting point of the sample was less than −15° C. according to differential scanning calorimetry (DSC) measurement. Diluting a 1% sample of this solution in 342 ppm hardness water resulted in the formation of an opaque, oil-in-water emulsion.

### Example 14

### Herbicidal Aqueous Composition of 2,4-D DMA, halauxifen-methyl and fluoroxypyr-meptyl

The halauxifen-methyl/fluoroxypyr-meptyl concentrate solution (Example 10, 13.33 g) and additional Genagen 4166 solvent (6.5 g) were mixed well together to provide a homogeneous organic phase, to which the 2,4-D DMA aqueous concentrate (Example 2, 76.0 g) was added. Upon mild hand mixing, a transparent and homogenous aqueous solution was formed that remained as a transparent and homogenous solution without any crystal formation/growth or phase separation after: (1) 2 weeks storage at freeze-thaw (F/T) conditions (−10° C./40° C. cycle every 24 hours), and (2) storage at 54° C. for 2 weeks. Diluting a 5% sample of this solution in 342 ppm hardness water resulted in the formation of an opaque, oil-in-water emulsion. The emulsion was free of cream or oil formation after 24 hours at ambient temperature.

### Example 15

### Halauxifen-methyl Concentrate in Solvent of Genagen 4166 and Agnique ME 1218

A halauxifen-methyl concentrate solution in a mixed solvent of Genagen 4166 and Agnique ME 1218 was prepared by dissolving halauxifen-methyl (5.00 active ingredient (ai) wt %) in a mixture of Genagen 4166 (47.50 wt %) and Agnique ME 1218 (47.50 wt %) until a transparent, homogeneous solution was obtained at ambient temperature.

### Example 16

### Halauxifen-methyl Concentrate in Solvent of Genagen 4166 and Aromatic A-200

A halauxifen-methyl concentrate solution in a mixed solvent of Genagen 4166 and Aromatic A-200 was prepared by dissolving halauxifen-methyl (5.00 active ingredient (ai) wt %) in a mixed solvent of Genagen 4166 (47.50 wt %) and Aromatic A-200 (47.50 wt %) until a transparent, homogeneous solution was obtained at ambient temperature.

### Example 17

### Halauxifen-methyl Concentrate in Solvent of Genagen 4166

A halauxifen-methyl concentrate solution in Genagen 4166 solvent was prepared by dissolving halauxifen-methyl (5.00 active ingredient (ai) wt %) in Genagen 4166 (95.00 wt %) until a transparent, homogeneous solution was obtained at ambient temperature.

### Examples 18-22

### Herbicidal Aqueous Compositions of 2,4-D DMA and halauxifen-methyl

Samples of 2.0 g, 4.0 g, 8.0 g, 12.0 g, and 16.0 g of the concentrate prepared in Example 15 were used as the homogeneous organic phase to which 18.0 g, 16.0 g, 12.0 g, 8.0 g, and 4.0 g, respectively, of the 2,4-D DMA aqueous concentrate from Example 2 were added. Upon mild hand mixing of each sample, transparent and homogenous, aqueous solutions were formed that remained as transparent and homogenous solutions without any crystal formation/growth or phase separation after at least 1 week of storage at ambient temperature. The aqueous solutions were then diluted in tap water in a ratio of 1:100 (w/w) at ambient temperature. After hand mixing the diluted samples, opaque oil-in-water emulsions were formed with no oil-water separation observed after being allowed to sit for 2 hours.

### Examples 23-27

### Herbicidal Aqueous Compositions of 2,4-D DMA and halauxifen-methyl

Samples of 2.0 g, 4.0 g, 8.0 g, 12.0 g, and 16.0 g of the concentrate prepared in Example 16 were used as the homogeneous organic phase to which 18.0 g, 16.0 g, 12.0 g, 8.0 g, and 4.0 g, respectively, of the 2,4-D DMA aqueous concentrate from Example 2 were added. Upon mild hand mixing of each sample, transparent and homogenous, aqueous solutions were formed that remained as transparent and homogenous solutions without any crystal formation/growth or phase separation after at least 1 week of storage at ambient temperature. The aqueous solutions were then diluted in tap water in a ratio of 1:100 (w/w) at ambient temperature. After hand mixing the diluted samples, opaque oil-in-water emulsions were formed with no oil-water separation observed after being allowed to sit for 2 hours.

### Example 28

### 2-methyl-4-chlorophenoxyacetic acid (MCPA) dimethylammnoium (DMA) Salt Aqueous Concentrate

An MCPA DMA salt aqueous concentrate solution was prepared by reacting MCPA technical with an equimolar amount of dimethylamine (40 wt %) solution in water at ambient temperature. Additional water was then added, if needed, to reach a target MCPA acid equivalent (ae) concentration of 52.00 wt %.

### Examples 29-33

### Herbicidal Aqueous Compositions of MCPA DMA and halauxifen-methyl

Samples of 2.0 g, 4.0 g, 8.0 g, 12.0 g, and 16.0 g of the concentrate prepared in Example 15 were used as the homogeneous organic phase to which 18.0 g, 16.0 g, 12.0 g, 8.0 g, and 4.0 g, respectively, of the MCPA DMA aqueous concentrate from Example 28 were added. Upon mild hand mixing of each sample, transparent and homogenous, aqueous solutions were formed that remained as transparent and homogenous solutions without any crystal formation/growth or phase separation after at least 1 week of storage at ambient temperature. The aqueous solutions were then diluted in tap water in a ratio of 1:100 (w/w) at ambient temperature. After hand mixing the diluted samples, opaque oil-in-water emulsions were formed with no oil-water separation observed after being allowed to sit for 2 hours.

### Examples 34-38

### Herbicidal Aqueous Compositions of MCPA DMA and halauxifen-methyl

Samples of 2.0 g, 4.0 g, 8.0 g, 12.0 g, and 16.0 g of the concentrate prepared in Example 16 were used as the homogeneous organic phase to which 18.0 g, 16.0 g, 12.0 g, 8.0 g, and 4.0 g, respectively, of the MCPA DMA aqueous concentrate from Example 28 were added. Upon mild hand mixing of each sample, transparent and homogenous, aqueous solutions were formed that remained as transparent and homogenous solutions without any crystal formation/growth or phase separation after at least 1 week of storage at ambient temperature. The aqueous solutions were then diluted in tap water in a ratio of 1:100 (w/w) at ambient temperature. After hand mixing the diluted samples, opaque oil-in-water emulsions were formed with no oil-water separation observed after being allowed to sit for 2 hours.

### Example 39

### 3,6-dichloro-2-pyridinecarboxylic acid monoethanol amine (clopyralid olamine) Salt Aqueous Concentrate

A clopyralid olamine salt aqueous concentrate solution was prepared by dissolving solid clopyralid olamine in water at ambient temperature to form a clear solution with a clopyralid acid equivalent (ae) concentration of 53.12 wt %.

### Example 40

### Clopyralid Olamine and 2,4-D DMA Aqueous Concentrate

A clopyralid olamine salt and 2,4-D DMA salt aqueous concentrate solution was prepared by mixing the 2,4-D DMA salt aqueous concentrate prepared in Example 2 with the clopyralid olamine salt aqueous concentrate prepared in Example 39 at ambient temperature. A clear solution was formed with a 2,4-D acid equivalent (ae) concentration of 47.14 wt %, and a clopyralid acid equivalent (ae) concentration of 7.86 wt %.

### Example 41-42

### Herbicidal Aqueous Composition of Clopyralid Olamine and 2,4-D DMA and halauxifen-methyl

Samples of 2.0 g and 4.0 g of the concentrate prepared in Example 17 were used as the homogeneous organic phase to which 18.0 g and 16.0 g, respectively, of the clopyralid olamine and 2,4-D DMA aqueous concentrate prepared in Example 40 were added. Upon mild hand mixing, transparent and homogenous, aqueous solutions were formed that remained as transparent and homogenous solutions without any crystal formation/growth or phase separation after at least 1 week of storage at ambient temperature. The aqueous solutions were then diluted in tap water in a ratio of 1:100 (w/w) at ambient temperature. After hand mixing the diluted samples, opaque oil-in-water emulsions were formed with no oil-water separation observed after being allowed to sit for 2 hours.

### Example 43

### Cloquintocet acid dimethylammonium (CQC DMA) Salt Aqueous Concentrate

A CQC DMA salt aqueous concentrate solution was prepared by reacting CQC technical with an equimolar amount of dimethylamine (40 wt %) solution in water at ambient temperature. Additional water was then added, if needed, to reach a target CQC in acid equivalent (ae) concentration of 37.80 wt %.

### Example 44

### Herbicidal Aqueous Composition of Clopyralid Olamine, 2,4-D DMA, halauxifen-methyl, and CQC DMA

A 2.10 g sample of the concentrate prepared in Example 17 was used as the homogeneous organic phase to which 15.18 g of the 2,4-D DMA aqueous concentrate prepared in Example 2, 2.63 g of the clopyralid olamine concentrate prepared in Example 39, and 0.20 g of the CQC DMA concentrate prepared in Example 43 were added. Upon mild hand mixing, a transparent and homogenous, aqueous solution was formed that remained as a transparent and homogenous solution without any crystal formation/growth or phase separation after at least 1 week of storage at ambient temperature. The aqueous solution was then diluted in tap water in a ratio of 1:100 (w/w) at ambient temperature and after hand mixing, an opaque oil-in-water emulsion was formed with no oil-water separation observed after being allowed to sit for 2 hours.

### Example 45

### 3,5,6-trichloro-2-pyridinyloxyacetic acid 2-hydroxy-N,N,N-trimethylethanolammonium (triclopyr choline) Salt Aqueous Concentrate

A triclopyr choline salt aqueous concentrate solution was prepared by reacting triclopyr technical with an equimolar amount of choline hydroxide aqueous solution in water at ambient temperature. Additional water was then added, if needed, to reach a target triclopyr acid equivalent (ae) concentration of 480 g/L.

### Example 46-47

### Herbicidal Aqueous Composition of triclopyr choline and halauxifen-methyl

Samples of 2.0 g and 4.0 g of the concentrate prepared in Example 17 were used as the homogeneous organic phase to which 18.0 g and 12.0 g samples, respectively, of the triclopyr choline aqueous concentrate prepared in Example 45, were added. Upon mild hand mixing, transparent and homogenous, aqueous solutions were formed that remained as transparent and homogenous solutions without any crystal formation/growth or phase separation after at least 1 week of storage at ambient temperature. The aqueous solutions were then diluted in tap water in a ratio of 1:100 (w/w) at ambient temperature and after hand mixing, opaque oil-in-water emulsions were formed with no oil-water separation observed after being allowed to sit for 2 hours.

### Example 48

### 3,6-dichloro-2-methoxybenzoic acid dimethylammonium (dicamba DMA) Salt Aqueous Concentrate

A dicamba DMA salt aqueous concentrate solution was prepared by reacting dicamba technical with an equimolar amount of DMA solution (40 wt %) in water at ambient temperature. The final dicamba acid equivalent (ae) concentration was 65.8 wt %.

### Example 49

### Herbicidal Aqueous Composition of dicamba DMA and halauxifen-methyl

A 2.0 g sample of the concentrate prepared in Example 17 was used as the homogeneous organic phase, to which 17.6 g of the dicamba DMA aqueous concentrate prepared in Example 48 and 0.4 g of Atlox DM 13/6 were added. Upon mild hand mixing, a transparent and homogenous, aqueous solution was formed that remained as a transparent and homogenous solution without any crystal formation/growth or phase separation after at least 1 week of storage at ambient temperature. The aqueous solution was then diluted in tap water in a ratio of 1:100 (w/w) at ambient temperature and after hand mixing, an opaque oil-in-water emulsion was formed with no oil-water separation observed after being allowed to sit for 2 hours.

The present invention is not limited in scope by the embodiments disclosed herein which are intended as illustrations of a few aspects of the invention and any embodiments which are functionally equivalent are within the scope of this invention. Various modifications of the processes, methods, and compositions in addition to those shown and described herein will become apparent to those skilled in the art and are intended to fall within the scope of the appended claims. Further, while only certain representative combinations of the process and method steps and composition components disclosed herein are specifically discussed in the embodiments above, other combinations of the composition components and process and method steps will become apparent to those skilled in the art and also are intended to fall within the scope of the appended claims. Thus a combination of components or steps may be explicitly mentioned herein; however, other combinations of components and steps are included, even though not explicitly stated. The term comprising and variations thereof as used herein is used synonymously with the term including and variations thereof and are open, non-limiting terms.

What is claimed:

1. A stable aqueous herbicidal composition comprising:
a) a water soluble salt of a synthetic auxin herbicide comprising, with respect to the total composition, from about 100 grams acid equivalent per liter (g ae/L) to about 625 g ae/L;
b) a second herbicide comprising, with respect to the total composition, from about 0.1 gram g ae/L to about 400 g ae/L of a water insoluble herbicide;
c) from about 0 g/L to about 150 g/L, with respect to the total composition, of at least one of an ionic and a non-ionic surfactant;
d) from about 0 g/L to about 500 g/L, with respect to the total composition, of a water immiscible organic solvent; and
e) from about 200 g/L to about 800 g/L, with respect to the total composition, of water;
wherein the composition forms a stable, transparent, and homogenous herbicidal composition.

2. The herbicidal composition of claim 1, wherein the herbicidal composition shows no visible phase separation after storage at 54° C. for 2 weeks.

3. The herbicidal composition of claim 1, wherein the herbicidal composition shows no visible crystal formation after −10/40° C. freeze/thaw cycling conditions every 24 hours for 2 weeks.

4. The stable aqueous herbicidal composition of claim 1, wherein the synthetic auxin herbicide is 2,4-D, 2,4-DB, aminocyclopyrachlor, aminopyralid, clopyralid, dicamba, MCPA, MCPB, picloram, triclopyr, or mixtures thereof.

5. The stable aqueous herbicidal composition of claim 1, wherein the synthetic auxin herbicide comprises one or more organo ammonium cations.

6. The stable aqueous herbicidal composition of claim 5, wherein the organo ammonium cations are isopropyl ammonium, diglycol ammonium, dimethyl ammonium, diethyl ammonium, triethyl ammonium, dimethylethanol ammonium, diethanol ammonium, triethanol ammonium, triisopropanol ammonium, tetramethyl ammonium, choline, N,N-bis-(3-aminopropyl)methyl ammonium, or mixtures thereof.

7. The stable aqueous herbicidal composition of claim 1, further comprising an agriculturally acceptable adjuvant or carrier.

8. The stable aqueous herbicidal composition of claim 1, wherein the second herbicide is an aminopyralid ester, carfentrazone, clethodim, a clopyralid ester, cloransulam-methyl, cyhalofop-butyl, a dicamba ester, diclosulam, florasulam, flumioxazin, fluoroxypyr-meptyl, halauxifen-methyl, a haloxyfop ester, a haloxyfop-P ester, haloxyfop-P-methyl, isoxaben, MCPA-EHE, an MCPB ester, mesotrione, metosulam, oxyfluorfen, penoxsulam, a picloram ester, propanil, pyrosulfotole, pyroxsulam, quizalofop-P-ethyl, saflufenacil, sethoxydim, sulfentrazone, tefuryltrione, topramezone, a non-liquid triclopyr ester, a compound having the following Formula 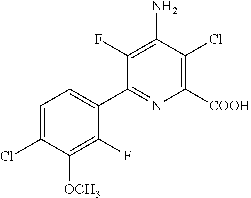 [SMILES: COc1c(Cl)ccc(-c2nc(C(=O)O)c(Cl)c(N)c2F)c1F]
or a C₁-C₁₂ alkyl or C₇-C₁₂ arylalkyl ester or salt thereof,
or mixtures thereof.

9. The herbicidal composition of claim 1, wherein the weight ratio on an acid equivalent (ae) basis of the synthetic auxin herbicide to the one or more second herbicide is from about 6250:1 to about 1:4.

10. A method of controlling undesirable vegetation comprising contacting the vegetation or an area adjacent thereto to prevent the emergence of growth of vegetation a herbicidally effective amount of a herbicidal composition comprising:
a. a water soluble salt of synthetic auxin herbicide comprising, with respect to the total composition, from about 100 g ae/L to about 625 g ae/L;
b. a second herbicide comprising, with respect to the total composition, from about 0.1 g ae/L to about 400 g ae/L of an aminopyralid ester, carfentrazone, clethodim, a clopyralid ester, cloransulam-methyl, cyhalofop-butyl, a dicamba ester, diclosulam, florasulam, flumioxazin, fluoroxypyr-meptyl, halauxifen-methyl, a haloxyfop ester, a haloxyfop-P ester, haloxyfop-P-methyl, isoxaben, MCPA-EHE, an MCPB ester, mesotrione, metosulam, oxyfluorfen, penoxsulam, a picloram ester, propanil, pyrosulfotole, pyroxsulam, quizalofop-P-ethyl, saflufenacil, sethoxydim, sulfentrazone, tefuryltrione, topramezone, a non-liquid triclopyr ester, a compound having the following Formula 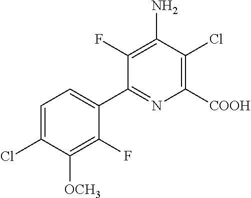 [SMILES: COc1c(Cl)ccc(-c2nc(C(=O)O)c(Cl)c(N)c2F)c1F]
or a C₁-C₁₂ alkyl or C₇-C₁₂ arylalkyl ester or salt thereof,
or mixtures thereof;
c. from about 0 g/L to about 150 g/L, with respect to the total composition, of at least one of an ionic and/or a non-ionic surfactant;
d. from about 0 g/L to about 500 g/L of a water immiscible organic solvent; and
e. from about 200 g/L to about 800 g/L, with respect to the total composition, of water;
wherein the composition forms a stable, transparent, and homogenous herbicidal composition.

11. The method of claim 10, wherein the herbicidal composition shows no visible phase separation after storage at 54° C. for 2 weeks.

12. The method of claim 10, wherein the herbicidal composition shows no visible crystal formation after storage at −10/40° C. freeze/thaw cycling conditions every 24 hours for 2 weeks.

13. The method of claim 10, wherein the water soluble salt of the synthetic auxin herbicide comprises one or more organo ammonium cations.

14. The method of claim 10, wherein the organo ammonium cations are isopropyl ammonium, diglycol ammonium, dimethyl ammonium, diethyl ammonium, triethyl ammonium, monoethanol ammonium, dimethylethanol ammonium, diethanol ammonium, triethanol ammonium, triisopropanol ammonium, tetramethyl ammonium, tetraethylammonium, choline, N,N-bis-(3-aminopropyl)methyl ammonium, or mixtures thereof.

15. The method of claim 10, wherein the weight ratio on an ae basis of the synthetic auxin herbicide to the one or more second herbicide is from about 6250:1 to about 1:4.

16. The method of claim 10, further comprising an agriculturally acceptable adjuvant or carrier.

17. The method of claim 10, further comprising a herbicide safener.

18. The method of claim 10, wherein the undesirable vegetation is controlled in a herbicide tolerant crop.

19. The method of claim 18, wherein the herbicide tolerant crop possesses single, multiple or stacked traits conferring tolerance to one or more herbicide chemistries and/or inhibitors with single or multiple modes of action.

20. The method of claim 10, wherein the undesirable vegetation comprises a herbicide resistant or tolerant weed.
